(19) United States
(12) Patent Application Publication
(10) Pub. No.: US 2026/0067685 A1
(43) Pub. Date: Mar. 5, 2026

(54) ACCESS AUTHENTICATION METHOD AND APPARATUS FOR PERSONAL IOT NETWORKS ELEMENT (PINE)

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/113,141

(22) PCT Filed: Sep. 30, 2022
(86) PCT No.: PCT/CN2022/123645

§ 371 Date: Mar. 19, 2025

(51) Int. Cl. H04W 12/06; H04L 9/40; H04L 61/4511; H04W 84/18

(52) U.S. Cl. CPC H04W 12/06; H04L 61/4511; H04L 63/0892; H04W 84/18

(57) ABSTRACT

A method for access authentication for a PINE, performed by a PEGC, includes: receiving an access request sent by the PINE, where the access request comprises identity information of the PINE; and sending a protocol data unit (PDU) session modification request to a session management function (SMF).

### CROSS-REFERENCE TO RELATED APPLICATION

This application is a U.S. national stage application of International Application No. PCT/CN2022/123645, filed Sep. 30, 2022, the entire contents of which are incorporated herein by reference.

### TECHNICAL FIELD

The present disclosure relates to the field of communication technology, and more particularly to a method and apparatus for access authentication for a PINE.

### BACKGROUND

In the related art, there is proposed such a gateway in a 5th generation mobile networks (5G) system that supports a personal IoT networks element (PINE) without a gateway capability to connect to a 5G core (5GC).

The PINE is connected to the 5GC via a personal IoT networks element with a gateway capability (PEGC).

However, identity authentication and authorization of the PINE are not supported in the related art, and there exists a risk that network resources are abused.

### SUMMARY

In a first aspect, embodiments of the present disclosure provide a method for access authentication for a PINE, which is performed by a PEGC, and includes: receiving an access request sent by the PINE, where the access request includes identity information of the PINE; and sending a protocol data unit (PDU) session modification request to a session management function (SMF).

In a second aspect, embodiments of the present disclosure provide another method for access authentication for a PINE, which is performed by an SMF, and includes: receiving a PDU session modification request sent by a PEGC, where the PDU session modification request is sent by the PEGC in a case where the PEGC receives an access request sent by the PINE, and the access request includes identity information of the PINE; and triggering an identity authentication of the PINE according to the PDU session modification request.

In a third aspect, embodiments of the present disclosure provide another method for access authentication for a PINE, which is performed by the PINE, and includes: sending an access request to a PEGC associated with the PINE or a PEGC to which the PINE belongs. The access request includes identity information of the PINE.

Embodiments of the present disclosure provide a communication apparatus, which includes a processor and a memory having stored therein a computer program. The processor is configured to perform the method according to the first aspect described above.

Embodiments of the present disclosure provide a communication apparatus, which includes a processor and a memory having stored therein a computer program. The processor is configured to perform the method according to the second aspect described above.

Embodiments of the present disclosure provide a communication apparatus, which includes a processor and a memory having stored therein a computer program. The processor is configured to perform the method according to the third aspect described above.

### BRIEF DESCRIPTION OF THE DRAWINGS

Drawings to be used for the description of the embodiments of the present disclosure are briefly described below.

FIG. 1 is an architecture diagram of a communication system according to embodiments of the present disclosure;

FIG. 2 is a flow chart of a method for access authentication for a PINE according to embodiments of the present disclosure;

FIG. 3 is a flow chart of another method for access authentication for a PINE according to embodiments of the present disclosure;

FIG. 4 is a flow chart of a method for an SMF to determine a configuration parameter corresponding to a PINE according to embodiments of the present disclosure;

FIG. 5 is a flow chart of yet another method for access authentication for a PINE according to embodiments of the present disclosure;

FIG. 6 is a flow chart of yet another method for access authentication for a PINE according to embodiments of the present disclosure;

FIG. 7 is a block diagram of a communication apparatus according to embodiments of the present disclosure;

FIG. 8 is an architecture block diagram of another communication system according to embodiments of the present disclosure;

FIG. 9 is a block diagram of another communication apparatus according to embodiments of the present disclosure; and

FIG. 10 is a block diagram of a chip according to embodiments of the present disclosure.

### DETAILED DESCRIPTION

In order to better understand a method and apparatus for access authentication for a PINE disclosed in embodiments of the present disclosure, a communication system to which embodiments of the present disclosure are applicable is firstly described below.

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. Instead, they are merely examples of apparatuses and methods consistent with some aspects of the present disclosure as recited in the appended claims.

Terms used in the present disclosure are for the purpose of describing specific embodiments, but should not be construed to limit the present disclosure. As used in the present disclosure and the appended claims, “a/an”, “said” and “the” in singular forms are intended to include plural forms, unless clearly indicated in the context otherwise. It should also be understood that, the term “and/or” used herein represents and contains any or all possible combinations of one or more associated listed items.

It should be understood that, although terms such as “first,” “second” and “third” may be used in the present disclosure for describing various information, these information should not be limited by these terms. These terms are used for distinguishing information of the same type from each other. For example, first information may also be referred to as second information, and similarly, the second information may also be referred to as the first information, without departing from the scope of the present disclosure. As used herein, the term “if” may be construed to mean “when” or “upon” or “in response to determining” depending on the context.

It should be noted that information (including, but not limited to, user equipment information, user personal information, etc.), data (including, but not limited to, data used for analysis, stored data, displayed data, etc.) and signals involved in the present disclosure are all authorized by a user or fully authorized by all parties, and collection, use and processing of relevant data need to comply with relevant laws, regulations and standards of relevant countries and regions.

It should be understood that the technical solutions of various embodiments of the present disclosure may be applied to various communication systems classified by access standards, for example, a global system of mobile communication (GSM), a code division multiple access (CDMA) system, a wideband code division multiple access (WCDMA), a general packet radio service (GPRS), a long term evolution (LTE), an LTE frequency division duplex (FDD) system, an LTE time division duplex (TDD), a universal mobile telecommunication system (UMTS), a wireless cellular network system, a 5G system, future communication systems, etc.

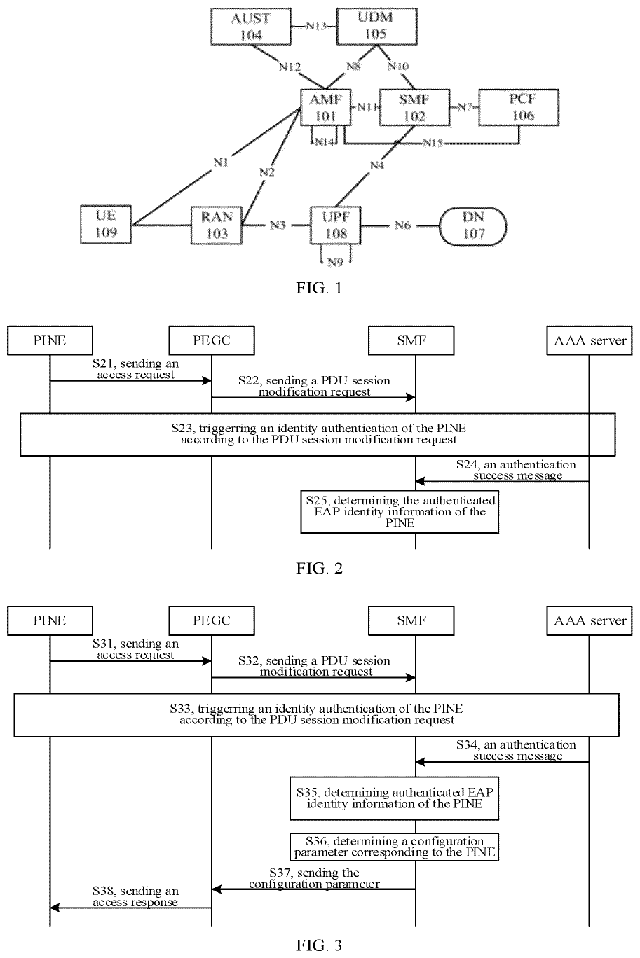

FIG. 1 shows a schematic diagram of a communication system 10 using a method for access authentication for a PINE of the present disclosure. As shown in FIG. 1, the communication system 10 mainly includes an access and mobility management function (AMF) 101, a session management function (SMF) device 102, a radio access network (RAN) 103, an authentication server function (AUSF) device 104, a unified data management (UDM) device 105, a policy control function (PCF) device 106, a data network (DN) 107, a user plane function (UPF) device 108, and a user equipment (UE) 109. The UE 109 is connected to the AMF 101 via an N1 interface, and the UE 109 is connected to the RAN 103 via a radio resource control (RRC) protocol; the RAN 103 is connected to the AMF 101 via an N2 interface, and the RAN 103 is connected to the UPF 108 via an N3 interface; a plurality of UPFs 108 are connected with one another via an N9 interface, the UPF 108 is connected to the DN 107 via an N6 interface, and at the same time, the UPF 108 is connected to the SMF 102 via an N4 interface; the SMF 102 is connected to the PCF 106 via an N7 interface, the SMF 102 is connected to the UDM 105 via an N10 interface, and at the same time, the SMF 102 is connected to the AMF 101 via an N11 interface; a plurality of AMFs 101 are connected with one another via an N14 interface, the AMF 101 is connected to the UDM 105 via an N8 interface, the AMF 101 is connected to the AUSF 104 via an N12 interface, and at the same time, the AMF 101 is connected to the PCF 106 via an N15 interface; the AUSF 104 is connected to the UDM 105 via an N13 interface. The AMF 101 and the SMF 102 obtain user subscription data from the UDM 105 via the N8 interface and the N10 interface respectively, and obtain policy data from the PCF 106 via the N15 interface and the N7 interface respectively. The SMF 102 controls the UPF 108 via the N4 interface.

The access and mobility management function (AMF) 101 is mainly used for a mobility management and an access management, etc., and may be used to implement functions other than session management of a mobility management entity (MME), such as a legal monitoring function and an access authorization/authentication function. It may be understood that an AMF network function is referred to as an AMF below for short. In embodiments of the present disclosure, the AMF may include an initial AMF, an old AMF and a target AMF. For example, the initial AMF may be understood as an AMF that first processes a UE registration request in a registration, and the initial AMF is selected by the (R)AN, however, the initial AMF may not necessarily serve this UE. The old AMF may be understood as an AMF that served the UE when the UE registered with a network last time. The target AMF may be understood as an AMF that serves the UE after re-registration of the UE.

SMF 102: it is used for a session management (such as session establishment, modification and release), a selection and control of a UPF 12, a selection of service and session continuity mode, and a roaming service, etc.

The (radio) access network ((R)AN) 103 is configured to provide a network access function for authorized terminals in a specific area, and may use transmission tunnels of different qualities according to a level of a terminal, a service requirement, etc. For example, the (R)AN may manage a radio resource, provide an access service for a terminal, and further complete forwarding of control information and/or data information between the terminal and a core network (CN). The access network device in embodiments of the present disclosure is a device that provides wireless communication functions for terminals, and may also be called a network device. For example, the access network device may include: a next generation node base station (gNB) in a 5G system, an evolved node B (eNB) in a long term evolution (LTE), a radio network controller (RNC), a node B (NB), a base station controller (BSC), a base transceiver station (BTS), a home base station (for example, a home evolved node B, or a home node B (HNB)), a base band unit (BBU), a transmitting and receiving point (TRP), a transmitting point (TP), a small base station device (pico), a mobile switching center, or a network device in a future network, etc. It may be understood that embodiments of the present disclosure do not limit the specific type of the access network device. In systems with different wireless access technologies, names of devices with an access network device function may be different.

AUSF 104: it is configured to interact with a UDM 20 to obtain user information and perform authentication-related functions, such as generating an intermediate key.

UDM 105: it is mainly configured to manage subscription information of terminals. In a 5G communication system, a unified data management network element may be a unified data management (UDM). In future communication systems (such as a 6G communication system), the unified data management network element may still be the UDM network element, or may have other names. The UDM 105 processes authentication information in 3GPP authentication and key negotiation mechanisms, processes user identity information, and performs access authorization, a registration and mobility management, a subscription management, a short message management, etc.

PCF 106: it includes a user subscription data management function, a policy control function, a charging policy control function, a quality of service (QoS) control, etc. In a 5G communication system, a policy control network element may be a policy control function (PCF). In future communication systems (such as a 6G communication system), the policy control network element may still be the PCF network element, or may have other names, which is not limited in the present disclosure.

DN 107 is a network that provides service serving to users. Generally, a client is located at a UE, and a server is located at a data network. The data network may be a personal network, such as a local area network, or an external network that is not controlled by the operator, such as an Internet, or may also be a proprietary network jointly deployed by operators, such as a network that provides internet protocol (IP) multimedia core network subsystem (IMS) services.

UPF 108: it is configured to process events related to a user plane, such as transmitting or routing data packets, detecting data packets, reporting traffic, processing quality of service (QoS), legal monitoring, storing downlink data packets, etc.

UE 109 (user equipment, also called terminal) is an entity on a user side for receiving or transmitting signals, such as a mobile phone. The terminal may also be called a terminal device, a user equipment, a mobile station (MS), a mobile terminal (MT), etc. The terminal may be a device with a communication function, such as a car, a smart car, a mobile phone, a wearable device, a tablet Pad, a computer with a wireless transceiver function, a virtual reality (VR) terminal, an augmented reality (AR) terminal, a wireless terminal in an industrial control, a wireless terminal in a self-driving, a wireless terminal in a remote medical surgery, a wireless terminal in a smart grid, a wireless terminal in a transportation safety, a wireless terminal in a smart city, a wireless terminal in a smart home, etc. Embodiments of the present disclosure do not limit the specific technology and the specific device form adopted by the terminal.

In this network architecture, the N1 interface is an interface between the terminal and the AMF. The N2 interface is an interface between the RAN and the AMF, and is configured to send non-access stratum (NAS) messages, etc. The N3 interface is an interface between the (R)AN and the UPF, and is configured to transmit user plane data, etc. The N4 interface is an interface between the SMF and the UPF, and is configured to transmit information such as tunnel identification information from N3 connection, data cache indication information, downlink data notification messages, etc. The N6 interface is an interface between the UPF and the DN, and is configured to transmit the user plane data, etc.

It may be understood that the terms introduced above may have different names in different fields or different standards, so the names shown above should not be understood as limitations on embodiments of the present disclosure. The above network functions or functions may be network elements in a hardware device, software functions running on a dedicated hardware, or virtualized functions instantiated on a platform (e.g., a cloud platform).

It should be noted that the network element involved in embodiments of the present disclosure may also be referred to as a functional device, a function, an entity, or a functional entity. For example, an access and mobility management network element may also be referred to as an access and mobility management functional device, an access and mobility management functional entity, or an access and mobility management functional entity. Names of various functional devices are not limited in the present disclosure. Those skilled in the art may replace the names of the above functional devices with other names, but perform the same functions, which all fall within the scope of protection of the present disclosure. The above functional devices may be network elements in hardware devices, software functions running on the dedicated hardware, or virtualized functions instantiated on a platform (e.g., a cloud platform).

It may be understood that the communication system and the network architecture described in embodiments of the present disclosure are intended to more clearly illustrate the technical solutions of embodiments of the present disclosure, and do not constitute a restriction on the technical solutions provided by embodiments of the present disclosure. Those of ordinary skill in the art may know that with the evolution of the system architecture and emergence of a new service scenario, the technical solutions provided by embodiments of the present disclosure are also applicable to similar technical problems.

A method and apparatus for access authentication for a PINE provided by the present disclosure will be introduced in detail below with reference to the accompanying drawings.

In the related art, a key aspect for a 5G system to support personal IoT networks (PIN) to connect to a 5GC is that PINE acts as a gateway for the PIN to connect to the 5GC. (A key aspect of the planned support of the 5G system for PIN is the ability of a UE (referred to as PEGC) to act as a gateway for PIN elements (PINEs), which are not acting as 5G UEs, to connect to 5GC.)

A PINE without a 3GPP capability cannot directly connect to the 5GC, but through the PEGC. Whether the PINE without 3GPP capability needs to be known by the 5GC and how to identify the PINE need to be studied, for example, for controlling access of the PINE to connecting 5G data networks, differentiating the PINE for policy configuration, and authorizing the PINE for atraffic delay, etc. (A PINE without 3GPP capability cannot directly connect to the 5GC, but through the PEGC. Whether the PINE without 3GPP capability needs to be known by the 5GC and how to identify the PINE needs to be studied, e.g., for controlling access of the PINE to connecting 5G data networks, differentiating the PINE for policy provisioning, authorizing the PINE for traffic relay, etc.)

5GS supports the policy and QoS differentiation for the traffic between a PINE and 5GS. The network resource may be misused by the malicious, unauthenticated, and unauthorized PINE. (5GS supports the policy and QoS differentiation for the traffic between a PINE and 5GS. The network resource may be misused by the malicious, unauthenticated, and unauthorized PINE.)

However, the related art does not support the 5GS to authenticate and authorize the PIN element (PINE). (However, there is no existing mechanism to enable 5GS to authenticate and authorize the PIN element.)

In view of this, in embodiments of the present disclosure, a method and apparatus for access authentication for a PINE are provided to support identity authentication and authorization for the PINE to avoid abuse of network resources.

In embodiments of the present disclosure, it is assumed that the PINE is authenticated based on the default credential via EAP methods, which is provisioned during production. (It is assumed that PINE is authenticated based on the default credential via EAP methods, which is provisioned during production.)

PIN AS does not provide credential to the PINE. (PIN AS does not provision credential to the PINE.)

PIN AS creates a correlation among a PIN related policy, a PIN ID, a PEGC ID, a PEMC ID, a PINE ID, and an authenticated EAP identity of a specific PINE. (PIN AS creates the correlation among PINE related policy, the PIN ID, PEGC ID, PEMC ID, PINE ID, authenticated EAP identity of a specific PINE.)

PIN AS has provided the PINE related policy, the PIN ID, the PEGC ID, the PEMC ID, the PINE ID, and the authenticated EAP identity of the specific PINE to the UDR/PCF. (PIN AS has provisioned the PINE related policy, the PIN ID, PEGC ID, PEMC ID, PINE ID, authenticated EAP identity of a specific PINE to the UDR/PCF.)

In addition, in order to facilitate understanding of embodiments of the present disclosure, the following points are explained.

First, in embodiments of the present disclosure, “configured to indicate” may include “configured to directly indicate” and “configured to indirectly indicate”. When describing that a certain information is configured to indicate A, it may include that the information directly indicates A or indirectly indicates A, but it does not mean that A must be carried in the information.

Information indicated by certain information is called information to be indicated. In specific implementations, there are many ways to indicate the information to be indicated, for example, but not limited to, directly indicating the information to be indicated, such as by means of the information to be indicated itself, or an index of the information to be indicated, etc. The information to be indicated may also be indirectly indicated by indicating other information, and an association relationship exists between the other information and the information to be indicated. It is also possible to only indicate a part of the information to be indicated, while other parts of the information to be indicated are known or agreed in advance. For example, indication of specific information may be realized by means of an arrangement order of various pieces of information agreed upon in advance, such as specified in a protocol, thereby reducing the indication overhead to a certain extent.

The information to be indicated may be sent as a whole, or may be divided into multiple sub-information to send separately, and sending periods and/or sending occasions of these sub-information may be the same or different. Specific sending manners are not limited in the present disclosure. The sending periods and/or sending occasions of these sub-information may be predefined, for example, predefined according to a protocol.

Second, “protocol” involved in embodiments of the present disclosure may refer to a standard protocol in the communication field, for example, including an LTE protocol, an NR protocol, and related protocols used in future communication systems, which are not limited in the present disclosure.

Third, “store” and “save” involved in embodiments of the present disclosure may refer to storage in one or more memories. The one or more memories may be set separately or integrated in an encoder or decoder, a processor, or a communication apparatus. It is also possible to set a part of the one or more memories separately, and another part thereof is integrated into the decoder, the processor, or the communication apparatus. The type of the memory may be any form of storage medium, which is not limited in the present disclosure.

Fourth, a plurality of implementations are given for embodiments of the present disclosure to clearly illustrate the technical solutions of embodiments of the present disclosure. Of course, those skilled in the art may understand that a plurality of implementations provided in embodiments of the present disclosure may be performed individually, or may be performed together with methods of other embodiments in embodiments of the present disclosure, or may be performed further in combination with some methods in other related art; and embodiments of the present disclosure are not limited thereto.

Embodiments of the present disclosure provide a method and apparatus for access authentication for a PINE, which may authenticate and authorize the PINE and avoid abuse of network resources.

In a first aspect, embodiments of the present disclosure provide a method for access authentication for a PINE, which is performed by a PEGC, and includes: receiving an access request sent by the PINE, where the access request includes identity information of the PINE; and sending a protocol data unit (PDU) session modification request to a session management function (SMF).

In this technical solution, the PEGC receives the access request sent by the PINE, where the access request includes the identity information of the PINE; and the PEGC sends the protocol data unit (PDU) session modification request to the session management function (SMF). In this way, identity authentication and authorization of the PINE may be performed to avoid abuse of network resources.

In a second aspect, embodiments of the present disclosure provide another method for access authentication for a PINE, which is performed by an SMF, and includes: receiving a PDU session modification request sent by a PEGC, where the PDU session modification request is sent by the PEGC in a case where the PEGC receives an access request sent by the PINE, and the access request includes identity information of the PINE; and triggering an identity authentication of the PINE according to the PDU session modification request.

In a third aspect, embodiments of the present disclosure provide another method for access authentication for a PINE, which is performed by the PINE, and includes: sending an access request to a PEGC associated with the PINE or a PEGC to which the PINE belongs. The access request includes identity information of the PINE.

In a fourth aspect, embodiments of the present disclosure provide another method for access authentication for a PINE, which is performed by a policy control function (PCF), and includes: receiving a query request sent by an SMF; determining a configuration policy according to the query request; and sending the configuration policy to the SMF.

In a fifth aspect, embodiments of the present disclosure provide a communication apparatus, which has part or all of functions for implementing the PEGC in the method according to the first aspect described above. For example, the communication apparatus may have functions as described in some or all of embodiments in the present disclosure, or may also have functions to separately implement any of embodiments in the present disclosure. The functions may be implemented by hardware, or may be implemented by executing corresponding software on the hardware. The hardware or the software includes one or more elements or modules corresponding to the above functions.

The communication apparatus includes: a transceiver module configured to receive an access request sent by a PINE, where the access request includes identity information of the PINE; and the transceiver module is further configured to send a protocol data unit (PDU) session modification request to a session management function (SMF).

In a sixth aspect, embodiments of the present disclosure provide another communication apparatus, which has part or all of functions for implementing the SMF in the method example according to the second aspect described above. For example, the communication apparatus may have functions as described in some or all of embodiments in the present disclosure, or may also have functions to separately implement any of embodiments in the present disclosure. The functions may be implemented by hardware, or may be implemented by executing corresponding software on the hardware. The hardware or the software includes one or more elements or modules corresponding to the above functions.

The communication apparatus includes: a transceiver module configured to receive a PDU session modification request sent by a PEGC, where the PDU session modification request is sent by the PEGC in a case where the PEGC receives an access request sent by a PINE, and the access request includes identity information of the PINE; and a processing module configured to perform identity authentication of the PINE according to the PDU session modification request.

In a seventh aspect, embodiments of the present disclosure provide another communication apparatus, which has part or all of functions for implementing the PINE in the method example according to the third aspect described above. For example, the communication apparatus may have functions as described in some or all of embodiments in the present disclosure, or may also have functions to separately implement any of embodiments in the present disclosure. The functions may be implemented by hardware, or may be implemented by executing corresponding software on the hardware. The hardware or the software includes one or more elements or modules corresponding to the above functions.

The communication apparatus includes: a transceiver module configured to send an access request to a PEGC associated with a PINE or a PEGC to which a PINE belongs. The access request includes identity information of the PINE.

In an eighth aspect, embodiments of the present disclosure provide another communication apparatus, which has part or all of functions for implementing the PCF in the method example according to the fourth aspect described above. For example, the communication apparatus may have functions as described in some or all of embodiments in the present disclosure, or may also have functions to separately implement any of embodiments in the present disclosure. The functions may be implemented by hardware, or may be implemented by executing corresponding software on the hardware. The hardware or the software includes one or more elements or modules corresponding to the above functions.

The communication apparatus includes: a transceiver module configured to receive a query request sent by an SMF; a processing module configured to determine a configuration policy according to the query request; and the transceiver module is further configured to send the configuration policy to the SMF.

In a ninth aspect, embodiments of the present disclosure provide a communication apparatus, which includes a processor. When the processor invokes a computer program in a memory, the method according to the first aspect described above is implemented.

In a tenth aspect, embodiments of the present disclosure provide a communication apparatus, which includes a processor. When the processor invokes a computer program in a memory, the method according to the second aspect described above is implemented.

In an eleventh aspect, embodiments of the present disclosure provide a communication apparatus, which includes a processor. When the processor invokes a computer program in a memory, the method according to the third aspect described above is implemented.

In a twelfth aspect, embodiments of the present disclosure provide a communication apparatus, which includes a processor. When the processor invokes a computer program in a memory, the method according to the fourth aspect described above is implemented.

In a thirteenth aspect, embodiments of the present disclosure provide a communication apparatus, which includes a processor and a memory having stored therein a computer program. The processor executes the computer program stored in the memory, to cause the communication apparatus to implement the method according to the first aspect described above.

In a fourteenth aspect, embodiments of the present disclosure provide a communication apparatus, which includes a processor and a memory having stored therein a computer program. The processor executes the computer program stored in the memory, to cause the communication apparatus to implement the method according to the second aspect described above.

In a fifteenth aspect, embodiments of the present disclosure provide a communication apparatus, which includes a processor and a memory having stored therein a computer program. The processor executes the computer program stored in the memory, to cause the communication apparatus to implement the method according to the third aspect described above.

In a sixteenth aspect, embodiments of the present disclosure provide a communication apparatus, which includes a processor and a memory having stored therein a computer program. The processor executes the computer program stored in the memory, to cause the communication apparatus to implement the method according to the fourth aspect described above.

In a seventeenth aspect, embodiments of the present disclosure provide a communication apparatus, which includes a processor and an interface circuit. The interface circuit is configured to receive code instructions and transmit the code instructions to the processor, and the processor is configured to run the code instructions to make the apparatus implement the method according to the first aspect described above.

In an eighteenth aspect, embodiments of the present disclosure provide a communication apparatus, which includes a processor and an interface circuit. The interface circuit is configured to receive code instructions and transmit the code instructions to the processor, and the processor is configured to run the code instructions to make the apparatus implement the method according to the second aspect described above.

In a nineteenth aspect, embodiments of the present disclosure provide a communication apparatus, which includes a processor and an interface circuit. The interface circuit is configured to receive code instructions and transmit the code instructions to the processor, and the processor is configured to run the code instructions to make the apparatus implement the method according to the third aspect described above.

In a twentieth aspect, embodiments of the present disclosure provide a communication apparatus, which includes a processor and an interface circuit. The interface circuit is configured to receive code instructions and transmit the code instructions to the processor, and the processor is configured to run the code instructions to make the apparatus implement the method according to the fourth aspect described above.

In a twenty-first aspect, embodiments of the present disclosure provide a communication system, which includes the communication apparatus according to the fifth aspect, the communication apparatus according to the sixth aspect, and the communication apparatus according to the seventh aspect; or includes the communication apparatus according to the eighth aspect, the communication apparatus according to the ninth aspect, the communication apparatus according to the tenth aspect, and the communication apparatus according to the eleventh aspect; or includes the communication apparatus according to the twelfth aspect, the communication apparatus according to the thirteenth aspect, the communication apparatus according to the fourteenth aspect, and the communication apparatus according to the fifteenth aspect; or includes the communication apparatus according to the sixteenth aspect, the communication apparatus according to the seventeenth aspect, the communication apparatus according to the eighteenth aspect, and the communication apparatus according to the nineteenth aspect.

In a twenty-second aspect, embodiments of the present disclosure provide a non-transitory computer-readable storage medium for storing instructions used by the above terminal. The instructions, when executed, cause the terminal to implement the method according to the first aspect described above.

In a twenty-third aspect, embodiments of the present disclosure provide a non-transitory computer-readable storage medium for storing instructions used by the above SMF. The instructions, when executed, cause the SMF to implement the method according to the second aspect described above.

In a twenty-fourth aspect, embodiments of the present disclosure provide a non-transitory computer-readable storage medium for storing instructions used by the above PCF. The instructions, when executed, cause the PCF to implement the method according to the third aspect described above.

In a twenty-fifth aspect, embodiments of the present disclosure provide a non-transitory computer-readable storage medium for storing instructions used by the above core network. The instructions, when executed, cause the core network to implement the method according to the fourth aspect described above.

In a twenty-sixth aspect, the present disclosure further provides a computer program product, which includes a computer program that, when run on a computer, causes the computer to implement the method according to the first aspect described above.

In a twenty-seventh aspect, the present disclosure further provides a computer program product, which includes a computer program that, when run on a computer, causes the computer to implement the method according to the second aspect described above.

In a twenty-eighth aspect, the present disclosure further provides a computer program product, which includes a computer program that, when run on a computer, causes the computer to implement the method according to the third aspect described above.

In a twenty-ninth aspect, the present disclosure further provides a computer program product, which includes a computer program that, when run on a computer, causes the computer to implement the method according to the fourth aspect described above.

In a thirtieth aspect, the present disclosure provides a chip system, which includes at least one processor and an interface, for supporting a PEGC to implement functions involved in the first aspect, for example, determining or processing at least one of data and information involved in the above method. In a possible design, the chip system further includes a memory for storing computer programs and data necessary for the PEGC. The chip system may consist of chips, or may include chips and other discrete devices.

In a thirty-first aspect, the present disclosure provides a chip system, which includes at least one processor and an interface, for supporting an SMF to implement functions involved in the second aspect, for example, determining or processing at least one of data and information involved in the above method. In a possible design, the chip system further includes a memory for storing computer programs and data necessary for the SMF. The chip system may consist of chips, or may include chips and other discrete devices.

In a thirty-second aspect, the present disclosure provides a chip system, which includes at least one processor and an interface, for supporting a PINE to implement functions involved in the third aspect, for example, determining or processing at least one of data and information involved in the above method. In a possible design, the chip system further includes a memory for storing computer programs and data necessary for the PINE. The chip system may consist of chips, or may include chips and other discrete devices.

In a thirty-third aspect, the present disclosure provides a chip system, which includes at least one processor and an interface, for supporting a PCF to implement functions involved in the fourth aspect, for example, determining or processing at least one of data and information involved in the above method. In a possible design, the chip system further includes a memory for storing computer programs and data necessary for the PCF. The chip system may consist of chips, or may include chips and other discrete devices.

In a thirty-fourth aspect, the present disclosure provides a computer program that, when run on a computer, causes the computer to implement the method according to the first aspect described above.

In a thirty-fifth aspect, the present disclosure provides a computer program that, when run on a computer, causes the computer to implement the method according to the second aspect described above.

In a thirty-sixth aspect, the present disclosure provides a computer program that, when run on a computer, causes the computer to implement the method according to the third aspect described above.

In a thirty-seven aspect, the present disclosure provides a computer program that, when run on a computer, causes the computer to implement the method according to the fourth aspect described above.

Referring to FIG. 2, FIG. 2 is a flow chart of a method for access authentication for a PINE according to embodiments of the present disclosure. As shown in FIG. 2, the method may include, but is not limited to, the following steps.

In S21, the PINE sends an access request to a PEGC, and the access request includes identity information of the PINE.

In embodiments of the present disclosure, the PINE may send the access request to the PEGC, and may request to access a network via the PEGC. The access request includes the identity information of the PINE. The PINE may send the access request to a PEGC associated with the PINE or a PEGC to which the PINE belongs.

The PEGC may be a terminal. One terminal may act as the PEGC for a plurality of PIN networks, and there are a plurality of corresponding PIN IDs and PEGC IDs. There are a plurality of PINEs for one PEGC, so in order to configure a QoS of a certain PINE ID, it needs to determine which PEGC ID and which PIN ID the PINE ID is associated with.

In embodiments of the present disclosure, the PINE sends the access request to the PEGC, and a signaling used for the access request may be based on non-3GPP access (such as WIFI, Bluetooth) and application layer deployment. (The signaling exchange between PINE and PEGC is based on non-3GPP access (e.g. WIFI, Bluetooth) and application layer deployment.)

In some embodiments, the identity information of the PINE includes at least one of: extensible authentication protocol (EAP) identity information of the PINE; a media access control (MAC) address of the PINE; a permanent equipment identifier of the PINE; a device ID of the PINE; or a PINE ID of the PINE.

In embodiments of the present disclosure, the identity information of the PINE may include the EAP identity information of the PINE.

In embodiments of the present disclosure, the identity information of the PINE may include the MAC address of the PINE.

In embodiments of the present disclosure, the identity information of the PINE may include the permanent equipment identifier of the PINE.

In embodiments of the present disclosure, the identity information of the PINE may include the device ID of the PINE.

In embodiments of the present disclosure, the identity information of the PINE may include the PINE ID of the PINE.

The EAP identity information of the PINE may include information about the MAC address, the PEI, and the device ID in a username part.

In some embodiments, the access request further includes at least one of an address of an authentication, authorization, and accounting (AAA) server; a fully qualified domain name (FQDN) of an AAA server; or PIN information of a PIN to which the PINE belongs.

In embodiments of the present disclosure, the access request further includes the address of the AAA server.

In embodiments of the present disclosure, the access request further includes the FQDN of the AAA server.

In embodiments of the present disclosure, the access request further includes the PIN information of the PIN to which the PINE belongs.

The EAP identity information of the PINE may include at least one of: a media access control (MAC) address of the PINE; a permanent equipment identifier of the PINE; a device ID of the PINE; or a PINE ID of the PINE.

In embodiments of the present disclosure, the EAP identity information of the PINE may include the MAC address of the PINE.

In embodiments of the present disclosure, the EAP identity information of the PINE may include the permanent equipment identifier of the PINE.

In embodiments of the present disclosure, the EAP identity information of the PINE may include the device ID of the PINE.

In embodiments of the present disclosure, the EAP identity information of the PINE may include the PINE ID of the PINE.

In some possible implementations, after receiving the access request sent by the PINE, the PEGC may perform S22.

In S22, the PEGC sends a PDU session modification request to an SMF.

In embodiments of the present disclosure, after receiving the access request sent by the PINE, the PEGC may send the PDU session modification request to the SMF.

In some embodiments, the PDU session modification request includes at least one of: the identity information of the PINE; an address allocated by the PEGC for the PINE; a port allocated by the PEGC for the PINE; PIN information of a PIN to which the PINE belongs; an address of an AAA server; or an FQDN of an AAA server.

In embodiments of the present disclosure, the PDU session modification request includes the identity information of the PINE.

In embodiments of the present disclosure, the PDU session modification request includes the address allocated by the PEGC for the PINE.

In embodiments of the present disclosure, the PDU session modification request includes the port allocated by the PEGC for the PINE.

In embodiments of the present disclosure, the PDU session modification request includes the PIN information of the PIN to which the PINE belongs.

In embodiments of the present disclosure, the PDU session modification request includes the address of the AAA server.

In embodiments of the present disclosure, the PDU session modification request includes the FQDN of the AAA server.

In some embodiments, the PIN information of the PIN to which the PINE belongs includes at least one of: identification information of the PIN; identity information of a PEGC in the PIN; identity information of a PIN element with management capability (PEMC) in the PIN; identity information of a PEGC to which the PINE belongs in the PIN; or identity information of a PEGC associated with the PINE in the PIN.

In embodiments of the present disclosure, the PIN information of the PIN to which the PINE belongs includes the identification information of the PIN.

In embodiments of the present disclosure, the PIN information of the PIN to which the PINE belongs includes the identity information of the PEGC in the PIN. The identity information of the PEGC includes, for example, a PEGC ID, a generic public subscription identifier (GPSI) of the PEGC.

In embodiments of the present disclosure, the PIN information of the PIN to which the PINE belongs includes the identity information of the PIN element with management capability (PEMC) in the PIN. The identity information of the PEMC includes, for example, a PEMC ID, a GPSI of the PEMC.

In embodiments of the present disclosure, the PIN information of the PIN to which the PINE belongs includes the identity information of the PEGC to which the PINE belongs in the PIN.

In embodiments of the present disclosure, the PIN information of the PIN to which the PINE belongs includes the identity information of the PEGC associated with the PINE in the PIN.

In some possible implementations, after receiving the PDU session modification request sent by the PEGC, the SMF may perform S23.

In S23, the SMF triggers an identity authentication of the PINE according to the PDU session modification request.

In embodiments of the present disclosure, after receiving the PDU session modification request sent by the PEGC, the SMF may trigger the identity authentication of the PINE according to the PDU session modification request.

The SMF may determine a target AAA server. For example, the SMF may determine a target AAA server according to a local policy of the SMF, or may also determine a target AAA server according to the PDU session modification request.

In a case where the SMF determines the target AAA server, it may send the EAP identity information of the PINE in the PDU session modification request to the target AAA server to trigger the identity authentication of the PINE.

When the target AAA server performs the identity authentication of the PINE, the PINE may also send the PIN information of the PIN to which the PINE belongs to the AAA server, so that the AAA server may perform the identity authentication of the PINE according to the EAP identity information of the PINE sent by the SMF and the PIN information of the PIN to which the PINE belongs sent by the PINE.

In some embodiments, the SMF determines the target AAA server according to at least one of: an address of an AAA server; an FQDN of an AAA server; the EAP identity information of the PINE; or local configuration of the SMF.

In embodiments of the present disclosure, the SMF determines the target AAA server according to the address of the AAA server.

In embodiments of the present disclosure, the SMF determines the target AAA server according to the FQDN of the AAA server.

In embodiments of the present disclosure, the SMF determines the target AAA server according to the EAP identity information of the PINE.

In embodiments of the present disclosure, the SMF determines the target AAA server according to the local configuration of the SMF.

In some embodiments, the target AAA server may authenticate the EAP identity information of the PINE, in a case where the target AAA server receives the EAP identity information of the PINE in the PDU session modification request sent by the SMF. The target AAA server may send EAP authentication success information to the SMF in a case where the authentication is successful, and the target AAA server may send EAP authentication failure information to the SMF in a case where the authentication fails.

In embodiments of the present disclosure, the SMF may cancel the authentication process, in a case where the SMF receives the EAP authentication failure information sent by the target AAA server.

In embodiments of the present disclosure, the SMF may determine authenticated EAP identity information of the PINE, in a case where the SMF receives the EAP authentication success information sent by the target AAA server.

In S24, the SMF receives an authentication success message sent by the AAA server.

In S25, the SMF determines the authenticated EAP identity information of the PINE.

In embodiments of the present disclosure, upon receiving the EAP authentication success information sent by the target AAA server, the SMF determines the authenticated EAP identity information of the PINE. The SMF may identify whether the EAP identity information of the PINE is anonymous EAP identity information, and determine the authenticated EAP identity information of the PINE according to an identification result.

In a case where the EAP identity information of the PINE is the anonymous EAP identity information, the EAP authentication success information includes authenticated RAP identity information, and the SMF may determine that the authenticated RAP identity information is the authenticated EAP identity information of the PINE.

In a case where the EAP identity information of the PINE is common EAP identity information but not the anonymous EAP identity information, the SMF may determine that the authenticated EAP identity information of the PINE is the common EAP identity information in the PDU session modification request.

In some possible implementations, in a case where the EAP identity information of the PINE is the anonymous EAP identity information, the SMF may transmit an EAP message between the PINE and the target AAA server using an address and/or port allocated by the PEGC for the PINE in the PDU session modification request, so as to perform the identity authentication of the PINE.

The anonymous EAP identity information is obtained by setting, by the PINE, a username part in the EAP identity information to be anonymous, or obtained by ignoring, by the PINE, a username part in the EAP identity information.

By implementing embodiments of the present disclosure, the PINE sends the access request to the PEGC, and the access request includes the identity information of the PINE. The PINE sends the PDU session modification request to the SMF. The SMF triggers the identity authentication of the PINE according to the PDU session modification request. The SMF receives the authentication success message sent by the AAA server and determines the authenticated EAP identity information of the PINE. In this way, the PINE may be authenticated and authorized to avoid abuse of network resources.

Referring to FIG. 3, FIG. 3 is a flow chart of another method for access authentication for a PINE according to embodiments of the present disclosure. As shown in FIG. 3, the method may include, but is not limited to, the following steps.

In S31, the PINE sends an access request to a PEGC, and the access request includes identity information of the PINE.

In S32, the PEGC sends a PDU session modification request to an SMF.

In S33, the SMF triggers an identity authentication of the PINE according to the PDU session modification request.

In S34, the SMF receives an authentication success message sent by an AAA server.

In S35, the SMF determines authenticated EAP identity information of the PINE.

For the relevant descriptions of S31 to S35, reference may be made to the relevant descriptions in the above embodiments, which will not be repeated here.

In S36, the SMF determines a configuration parameter corresponding to the PINE.

In embodiments of the present disclosure, the SMF triggers the identity authentication of the PINE according to the PDU session modification request, and may determine the configuration parameter corresponding to the PINE in the case where the SMF receives the authentication success message and determines the authenticated EAP identity information of the PINE.

The ways for the SMF to determine the configuration parameter corresponding to the PINE may include that the SMF determines the configuration parameter according to local stored information, or obtains the configuration parameter from other functional network elements, or obtains such relevant information from other network elements that may be used to determine the configuration parameter. Embodiments of the present disclosure do not impose specific restrictions on this.

In some possible implementations, after determining the configuration parameter, the SMF performs S37.

In S37, the SMF sends the configuration parameter to the PEGC.

In embodiments of the present disclosure, after determining the configuration parameter, the SMF may send determined configuration parameter to the PEGC.

After receiving the configuration parameter sent by the SMF, the PEGC performs S39.

In S38, the PEGC sends an access response to the PINE.

In embodiments of the present disclosure, after receiving the configuration parameter sent by the SMF, the PEGC may send the access response to the PINE, which enables the PINE to access the network via the PEGC.

It should be noted that in embodiments of the present disclosure, S31 to S36 may be implemented separately or in combination with any other steps in embodiments of the present disclosure, for example, in combination with S21 to S23 in embodiments of the present disclosure, and embodiments of the present disclosure are not limited thereto.

By implementing embodiments of the present disclosure, the PINE sends the access request to the PEGC, and the access request includes the identity information of the PINE. The PINE sends the PDU session modification request to the SMF. The SMF triggers the identity authentication of the PINE according to the PDU session modification request. In response to receiving the authentication success message, the SMF determines the authenticated EAP identity information of the PINE and determines the configuration parameter corresponding to the PINE. The SMF sends the configuration parameter to the PEGC, and the PEGC sends the access response to the PINE. Therefore, the PINE accesses the network via the PEGC on the basis of the identity authentication and authorization of the PINE, which avoids abuse of network resources.

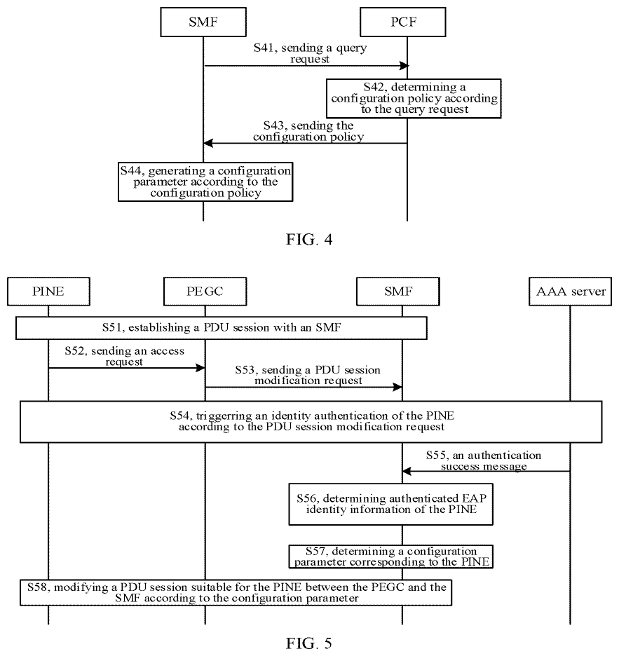

Referring to FIG. 4, FIG. 4 is a flow chart of a method for an SMF to determine a configuration parameter corresponding to a PINE according to embodiments of the present disclosure. As shown in FIG. 4, the method may include, but is not limited to, the following steps.

In S41, the SMF sends a query request to a PCF.

In S42, the PCF determines a configuration policy according to the query request.

In S43, the PCF sends the configuration policy to the SMF.

In S44, the SMF generates a configuration parameter according to the configuration policy.

In embodiments of the present disclosure, the SMF determines a configuration parameter corresponding to the PINE and may send the query request to the PCF.

In some embodiments, the query request includes at least one of: authenticated EAP identity information of the PINE; PIN information of a PIN to which the PINE belongs; or identity information of the PINE.

In embodiments of the present disclosure, the query request includes the authenticated EAP identity information in EAP authentication success information.

In embodiments of the present disclosure, the query request includes the PIN information of the PIN to which the PINE belongs.

In embodiments of the present disclosure, the query request includes the identity information of the PINE.

After receiving the query request sent by the SMF, the PCF may determine the configuration policy according to the query request.

In a possible implementation, the PCF obtains the configuration policy from the PCF locally according to the query request.

A manner in which the PCF obtains the configuration policy from the PCF locally according to the query request includes: determining a mapping relationship between the configuration policy and at least one of the authenticated EAP identity information, the PIN information of the PIN to which the PINE belongs, or the identity information of the PINE stored locally by the PCF; and determining the configuration policy according to the mapping relationship and at least one of the authenticated EAP identity information, the PIN information of the PIN to which the PINE belongs, or the identity information of the PINE.

For example, the PCF may determine the mapping relationship between the authenticated EAP identity information stored locally by the PCF and the configuration policy, and determine the configuration policy according to the mapping relationship and the authenticated EAP identity information in the query request.

For example, the PCF may determine the mapping relationship between the PIN information of the PIN to which the PINE belongs stored locally by the PCF and the configuration policy, and determine the configuration policy according to the mapping relationship and the PIN information of the PIN to which the PINE belongs in the query request.

For example, the PCF may determine the mapping relationship between the identity information of the PINE stored locally by the PCF and the configuration policy, and determine the configuration policy according to the mapping relationship and the identity information of the PINE in the query request.

In another possible implementation, the PCF obtains the configuration policy from a UDR according to the query request.

A manner in which the PCF obtains the configuration policy from the UDR according to the query request includes: sending at least one of the authenticated EAP identity information, the PIN information of the PIN to which the PINE belongs, or the identity information of the PINE in the query request to the UDR, and obtaining the configuration policy from the UDR. The UDR stores a mapping relationship between the configuration policy and at least one of the authenticated EAP identity information, the PIN information of the PIN to which the PINE belongs, or the identity information of the PINE.

For example, the PCF may send the authenticated EAP identity information in the query request to the UDR, and obtain the configuration policy from the UDR. The UDR stores the mapping relationship between the authenticated EAP identity information and the configuration policy.

For example, the PCF may send the PIN information of the PIN to which the PINE belongs in the query request to the UDR, and obtain the configuration policy from the UDR. The UDR stores the mapping relationship between the PIN information of the PIN to which the PINE belongs and the configuration policy.

For example, the PCF may send the identity information of the PINE in the query request to the UDR, and obtain the configuration policy from the UDR. The UDR stores the mapping relationship between the identity information of the PINE and the configuration policy.

In some embodiments, the mapping relationship is provided by an application function (AF) and/or application server (AS) related to the PIN.

In embodiments of the present disclosure, the mapping relationship between the configuration policy and at least one of the authenticated EAP identity information, the PIN information of the PIN to which the PINE belongs, or the identity information of the PINE is provided by the application function and/or application server related to the PIN.

For example, the mapping relationship may be provided by a PIN AS or a PIN AF.

In embodiments of the present disclosure, the PCF sends the configuration policy to the SMF, and the configuration policy includes QoS, URSP, connection information and the like of the PINE.

It should be noted that in embodiments of the present disclosure, S41 to S44 may be implemented separately or in combination with any other steps in embodiments of the present disclosure, for example, in combination with S21 to S23 and/or S31 to S36 in embodiments of the present disclosure, and embodiments of the present disclosure are not limited thereto.

By implementing embodiments of the present disclosure, the SMF sends the query request to the PCF, the PCF determines the configuration policy according to the query request, the PCF sends the configuration policy to the SMF, and the SMF generates the configuration parameter according to the configuration policy. Therefore, the SMF may determine the configuration parameter corresponding to the PINE.

Referring to FIG. 5, FIG. 5 is a flow chart of yet another method for access authentication for a PINE according to embodiments of the present disclosure. As shown in FIG. 5, the method may include, but is not limited to, the following steps.

In S51, the PINE establishes a PDU session with an SMF.

In embodiments of the present disclosure, for a manner in which the PINE establishes the PDU session with the SMF, reference may be made to the manner in the related art, which will not be repeated here.

In S52, the PINE sends an access request to a PEGC, and the access request includes identity information of the PINE.

In S53, the PEGC sends a PDU session modification request to the SMF.

In S54, the SMF triggers an identity authentication of the PINE according to the PDU session modification request.

In S55, the SMF receives an authentication success message sent by an AAA server.

In S56, the SMF determines authenticated EAP identity information of the PINE.

In S57, the SMF determines a configuration parameter corresponding to the PINE.

For the relevant descriptions of S51 to S57, reference may be made to the relevant descriptions in the above embodiments, which will not be repeated here.

In S58, the SMF modifies a PDU session suitable for the PINE between the PEGC and the SMF according to the configuration parameter.

In embodiments of the present disclosure, the SMF receives the PDU session modification request sent by the PEGC, and may trigger the identity authentication of the PINE in the process of performing the PDU session modification, determines the configuration parameter corresponding to the PINE when receiving the authentication success message, and modifies the PDU session suitable for the PINE between the PEGC and the SMF according to the configuration parameter, thereby realizing the modification of the PDU session.

By implementing embodiments of the present disclosure, the PINE establishes the PDU session with the SMF, the PINE sends the access request to the PEGC, and the access request includes the identity information of the PINE, the PINE sends the PDU session modification request to the SMF, the SMF triggers the identity authentication of the PINE according to the PDU session modification request, the SMF determines the authenticated EAP identity information of the PINE in response to receiving the authentication success message, and determines the configuration parameter corresponding to the PINE, and the SMF modifies the PDU session suitable for the PINE between the PEGC and the SMF according to the configuration parameter. In this way, it is possible to authenticate and authorize the PINE to avoid abuse of network resources.

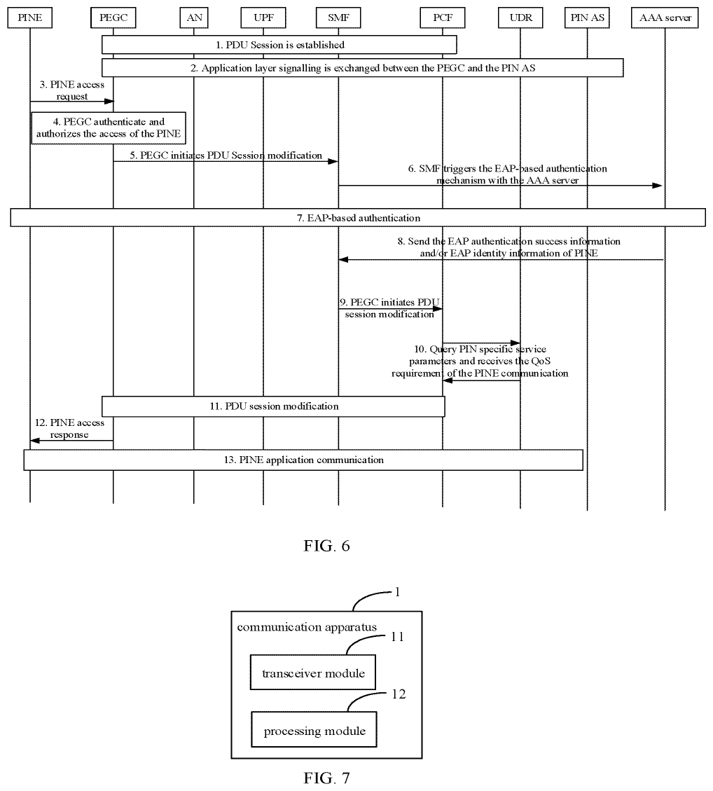

Referring to FIG. 6, FIG. 6 is a flow chart of yet another method for access authentication for a PINE according to embodiments of the present disclosure. As shown in FIG. 6, the method may include, but is not limited to, the following steps.

1. PDU session of PEGC is established. (PDU Session of PEGC is established.)

2. Application layer signaling is exchanged between the PEGC and the PIN AS. A list of PINEs authorized to access the PEGC are provided to the PEGC. (Application layer signalling is exchanged between the PEGC and the PIN AS. A list of PINEs authorized to access the PEGC are provisioned to the PEGC.)

3. PINE requests (via an access request) to access the PEGC for traffic relay to 5GS. The access request includes identity information of PINE, external AAA server address (optional). The identity information of PINE includes EAP identity information of PINE, PINE ID of PINE. EAP identity information of PINE can contain information about MAC address, PEI, device ID in the username part. (A PINE requests to access the PEGC for traffic relay to 5GS. The request includes identities of PINE, external AAA server address (optional). The identities of PINE include EAP identity of PINE, PINE ID of PINE. EAP identity of PINE can contains information about MAC Address, PEI, device ID in the username part.)

The signaling exchange between PINE and PEGC is based on non-3GPP access (e.g. WIFI, Bluetooth) and application layer deployment. (The signalling exchange between PINE and PEGC is based on non-3GPP access (e.g. WIFI, Bluetooth) and application layer deployment.)

4. The PEGC authenticates and authorizes the access of the PINE, and allocates IP address for the PINE. This procedure is realized based on non-3GPP access, which is out of scope of 3GPP. (The PEGC authenticate and authorizes the access of the PINE, and allocates IP address for the PINE. This procedure is realized based on non-3GPP access, which is out of scope of 3GPP.)

5. The PEGC initiates PDU session modification. (The PEGC initiates PDU Session modification.)

The PEGC sends the PINE information (PDU session modification request) to the SMF via NAS signaling, including the EAP identity information of PINE, address of the external AAA server (optional), PINE ID, IP address of the PINE, IP address and allocated port number in case of NAT applied. Since a PINE may connect to multiple PEGCs, PEMCs, and PINs, the PEGC should send the PIN, PEGC and PEMC information, which is related to the PINE, to the SMF. Specifically, the PINE information also includes identity information of PIN (e.g., PIN ID), identity information of PEMC (e.g., PEMC ID, GPSI of PEMC), and identity information of PEGC (e.g., PEGC ID, GPSI of PEGC) to uniquely identify the configuration policy. (The PEGC sends the PINE information to the SMF via NAS signalling, include the EAP identity of PINE, address of the external AAA server (optional), PINE ID, IP address of the PINE, IP address and allocated port number in case of NAT applied. Since a PINE may connect to multiple PEGCs, PEMCs, and PINs, the PEGC should send the PIN, PEGC, and PEMC information, which is related to the PINE, to the SMF. Specifically, the PINE information also include identities of PIN (e.g., PIN ID), identities of PEMC (e.g., PEMC ID, GPSI of PEMC), and identities of PEGC (e.g., PEGC ID, GPSI of PEGC) to the SMF to uniquely identify the policy.)

6-8. SMF can select the AAA server based on the username part of the EAP identity information, the AAA server information that is provided by the PINE, or the local configuration. SMF triggers the EAP-based authentication mechanism with the external AAA server. The external AAA server may send the EAP authentication success information and/or EAP identity information of PINE. SMF terminates the procedure if the authentication is failed. (SMF can select the AAA server based on the realm part of the EAP identity or the AAA server address that is provided by the PINE. SMF triggers the EAP-based authentication mechanism with the external AAA server. The external AAA server may send the successfully authenticated EAP identity of PINE. SMF terminates the procedure if the authentication is failed.)

9. The SMF updates the PCF with the identity information of PIN, identity information of PEMC, identity information of PEGC, PINE ID, and authenticated EAP identity information of PINE. (The SMF updates the PCF with the identities of PIN, identities of PEMC, identities of PEGC, PINE ID, and authenticated EAP identity of PINE in SM Policy Association Modification.)

10. The PCF queries the UDR for PIN specific service parameters with the identity information of PIN, identity information of PEMC, identity information of PEGC, PINE ID, and authenticated EAP identity of PINE, and receives the QoS requirement of the PINE communication. (The PCF queries the UDR for PIN Specific Service Parameters with the identities of PIN, identities of PEMC, identities of PEGC, PINE ID, and authenticated EAP identity of PINE, and receives the QoS requirement of the PINE communication.)

The PCF derives the PCC rules for the PINE according to the QoS requirement received from the UDR and IP address/port number of the PINE from the SMF. (The PCF derives the PCC rules for the PINE according to the QoS requirement received from the UDR and IP address/port number of the PINE from the SMF.)

11. The PDU session modification procedure continues from step 2. The QoS flow for the PINE communication with 5GS is established. (The PDU Session Modification procedures as specified in clause 4.3.3.2 of TS 23.502 [3] continues from step 2. The QoS flow for the PINE communication with 5GS is established.)

12. The PEGC sends an access response to the PINE. (The PEGC sends a response to the PINE.)

13. The application traffic of the PINE is relayed to the 5GS via the PEGC. (The application traffic of the PINE is relayed to the 5GS via the PEGC.)

By implementing embodiments of the present disclosure, it is supported to enable the 5GS to authenticate and authorize the PINE, thereby avoiding the abuse of network resources.

In the above embodiments provided by the present disclosure, the solutions provided by embodiments of the present disclosure are mainly introduced from the perspective of interactions between devices. It may be understood that, in order to realize the above functions, each device includes a corresponding hardware structure and/or software module for executing respective function. It should be easily appreciated by those skilled in the art that, algorithm steps of various examples described with reference to embodiments disclosed herein may be implemented in a form of hardware or a combination of hardware and computer software. Whether a certain function is executed by the hardware or by the computer software driving the hardware depends on a specific application and design constraints of a technical solution. For each specific application, professional technicians may use different manners to implement the described functions, but such implementation should not be considered beyond the scope of the present disclosure.

Referring to FIG. 7, FIG. 7 is a block diagram of a communication apparatus 1 according to embodiments of the present disclosure. The communication apparatus 1 shown in FIG. 7 may include a transceiver module 11 and a processing module 12. The transceiver module 11 may include a sending module and/or a receiving module. The sending module is configured to implement a sending function, and the receiving module is configured to implement a receiving function. The transceiver module 11 may implement the sending function and/or the receiving function.

The communication apparatus 1 is arranged at a PEGC side and includes the transceiver module 11 and the processing module 12.

The transceiver module 11 is configured to receive an access request sent by a PINE, and the access request includes identity information of the PINE.

The transceiver module 11 is further configured to send a protocol data unit (PDU) session modification request to a session management function (SMF).

In some embodiments, the transceiver module 12 is further configured to receive a configuration parameter sent by the SMF; and send an access response to the PINE.

In some embodiments, the processing module 12 is configured to establish a PDU session with the SMF.

In some embodiments, the PDU session modification request includes at least one of: the identity information of the PINE; an address of the PINE; a port of the PINE; PIN information of a PIN to which the PINE belongs; an address of an AAA server; or an FQDN of an AAA server.

In some embodiments, the access request and the PDU session modification request further include at least one of: PIN information of a PIN to which the PINE belongs; an address of an AAA server; or an FQDN of an AAA server.

In some embodiments, the PIN information of the PIN to which the PINE belongs includes at least one of identification information of the PIN; identity information of a PEGC in the PIN; identity information of a PIN element with management capability (PEMC) in the PIN; identity information of a PEGC to which the PINE belongs in the PIN; or identity information of a PEGC associated with the PINE in the PIN.

In some embodiments, the identity information of the PINE includes at least one of: EAP identity information of the PINE; a MAC address of the PINE; a permanent equipment identifier of the PINE; a device ID of the PINE; or a PINE ID of the PINE.

The communication apparatus 1 is arranged at an SMF side and includes the transceiver module 11 and the processing module 12.

The transceiver module 11 is configured to receive a PDU session modification request sent by a PEGC, and the PDU session modification request is sent by the PEGC in a case where the PEGC receives an access request sent by the PINE, and the access request includes identity information of the PINE.

The processing module 12 is configured to trigger an identity authentication of the PINE according to the PDU session modification request.

In some embodiments, the processing module 12 is further configured to determine a target AAA server.

The transceiver module 11 is further configured to trigger the identity authentication of the PINE by sending EAP identity information of the PINE in the PDU session modification request to the target AAA server.

In some embodiments, the processing module 12 is further configured to determine the target AAA server according to at least one of: an address of the AAA server; an FQDN of the AAA server; the EAP identity information of the PINE; or local configuration of the SMF.

In some embodiments, the processing module 12 is further configured to determine authenticated EAP identity information of the PINE in response to receiving EAP authentication success information.

In some embodiments, the processing module 12 is further configured to: determine that authenticated EAP identity information is the authenticated EAP identity information of the PINE, in response to EAP identity information of the PINE being anonymous EAP identity information and the EAP authentication success information including the authenticated EAP identity information; or determine that the authenticated EAP identity information of the PINE is common EAP identity information in the PDU session modification request, in response to the EAP identity information of the PINE being common EAP identity information.

In some embodiments, the processing module 12 is further configured to perform the identity authentication of the PINE by transmitting an EAP message between the PINE and the target AAA server using an address and/or port of the PINE in the PDU session modification request, in response to the EAP identity information of the PINE being anonymous EAP identity information.

In some embodiments, the anonymous EAP identity information is obtained by setting, by the PINE, a username part in the EAP identity information to be anonymous, or obtained by ignoring, by the PINE, a username part in the EAP identity information.

In some embodiments, the processing module 12 is further configured to determine a configuration parameter corresponding to the PINE.

In some embodiments, the transceiver module 11 is further configured to send a query request to a PCF; and receive a configuration policy sent by the PCF.

The processing module 12 is further configured to determine the configuration parameter corresponding to the PINE according to the configuration policy.

In some embodiments, the processing module 12 is further configured to modify a PDU session suitable for the PINE between the PEGC and the SMF according to the configuration parameter.

In some embodiments, the query request includes at least one of: the authenticated EAP identity information of the PINE; PIN information of a PIN to which the PINE belongs; or the identity information of the PINE.

In some embodiments, the PDU session modification request includes at least one of: the identity information of the PINE; an address of the PINE; a port of the PINE; PIN information of a PIN to which the PINE belongs; an address of an AAA server; or an FQDN of an AAA server.

In some embodiments, the PIN information of the PIN to which the PINE belongs includes at least one of: identification information of the PIN; identity information of a PEGC in the PIN; identity information of a PEMC in the PIN; identity information of a PEGC to which the PINE belongs in the PIN; or identity information of a PEGC associated with the PINE in the PIN.

In some embodiments, the identity information of the PINE includes at least one of: EAP identity information of the PINE; a MAC address of the PINE; a permanent equipment identifier of the PINE; a device ID of the PINE; or a PINE ID of the PINE.

In some embodiments, the processing module 12 is further configured to establish a PDU session with the PEGC before receiving the PDU session modification request.

The communication apparatus 1 is arranged at a PINE side and includes the transceiver module 11.

The transceiver module 11 is configured to send an access request to a PEGC associated with the PINE or a PEGC to which the PINE belongs, and the access request includes identity information of the PINE.

In some embodiments, the transceiver module 11 is further configured to receive an EAP authentication request message sent by the PEGC; and send an EAP authentication response to the PEGC.

In some embodiments, the transceiver module 11 is further configured to receive an access response sent by the PEGC.

In some embodiments, the identity information of the PINE includes at least one of: EAP identity information of the PINE; a MAC address of the PINE; a permanent equipment identifier of the PINE; a device ID of the PINE; or a PINE ID of the PINE.

In some embodiments, the access request further includes at least one of: PIN information of a PIN to which the PINE belongs; an address of an AAA server; or an FQDN of an AAA server.

The communication apparatus 1 is arranged at a PCF side and includes the transceiver module 11 and the processing module 12.

The transceiver module 11 is configured to receive a query request sent by an SMF.

The processing module 12 is configured to determine a configuration policy according to the query request.

The transceiver module 11 is further configured to send the configuration policy to the SMF.

In some embodiments, the processing module 12 is further configured to obtain the configuration policy from the PCF locally according to the query request; or obtain the configuration policy from a UDR according to the query request.

In some embodiments, the query request includes at least one of: authenticated EAP identity information of the PINE; PIN information of a PIN to which the PINE belongs; or identity information of the PINE.

In some embodiments, the processing module 12 is further configured to: determine a mapping relationship between the configuration policy and at least one of the authenticated EAP identity information, the PIN information of the PIN to which the PINE belongs, or the identity information of the PINE stored locally by the PCF; and determine the configuration policy according to the mapping relationship and at least one of the authenticated EAP identity information, the PIN information of the PIN to which the PINE belongs, or the identity information of the PINE.

In some embodiments, the processing module 12 is further configured to: send at least one of the authenticated EAP identity information, the PIN information of the PIN to which the PINE belongs, or the identity information of the PINE in the query request to the UDR, and obtain the configuration policy from the UDR. The UDR stores a mapping relationship between the configuration policy and at least one of the authenticated EAP identity information, the PIN information of the PIN to which the PINE belongs, or the identity information of the PINE.

In some embodiments, the mapping relationship is provided by an application function and/or application server related to the PIN.

Regarding the communication apparatus 1 in the above embodiments, the specific manner in which each module performs operations has been described in detail in embodiments of the related methods, and will not be elaborated here.

The communication apparatus 1 provided by the above embodiments of the present disclosure achieves the same or similar beneficial effects as the method for the access authentication for the PINE provided by some embodiments above, which will not be repeated here.

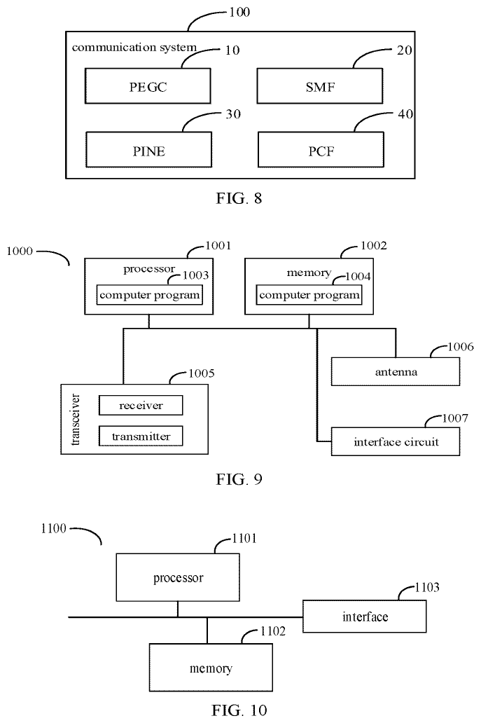

Referring to FIG. 8, FIG. 8 is an architecture block diagram of another communication system according to embodiments of the present disclosure.

As shown in FIG. 8, the communication system 100 includes: a PEGC, an SMF, a PINE and a PCF.

The PEGC is configured to perform the method according to some embodiments above; the SMF is configured to perform the method according to some embodiments above; the PINE is configured to perform the method according to some embodiments above; and the PCF is configured to perform the method according to some embodiments above.

Regarding the communication system 100 in the above embodiments, the specific manner in which each module performs operations has been described in detail in embodiments of the related methods, and will not be elaborated here.

The communication system 100 provided in the above embodiments of the present disclosure achieves the same or similar beneficial effects as the method for the access authentication for the PINE provided in some embodiments above, which will not be repeated here.

Referring to FIG. 9, FIG. 9 is a block diagram of another communication apparatus 1000 according to embodiments of the present disclosure. The communication apparatus 1000 may be a terminal, may also be an SMF, or may also be a PCF. The apparatus may be used to implement the methods described in the above method embodiments, and for details, reference may be made to the descriptions on the above method embodiments.

The communication apparatus 1000 may include at least one processor 1001. The processor 1001 may be a general-purpose processor or a special-purpose processor. For example, it may be a baseband processor or a central processing unit. The baseband processor may be configured to process a communication protocol and communication data, and the central processing unit may be configured to control a communication apparatus (such as a base station, a baseband chip, a terminal, a terminal chip, a DU or a CU, etc.), execute computer programs, and process data of computer programs.

Optionally, the communication apparatus 1000 may further include at least one memory 1002 that may have stored therein a computer program 1004. The memory 1002 executes the computer program 1004 to cause the communication apparatus 1000 to implement the methods as described in the above method embodiments. Optionally, the memory 1002 may have stored therein data. The communication apparatus 1000 and the memory 1002 may be set separately or integrated together.

Optionally, the communication apparatus 1000 may further include a transceiver 1005 and an antenna 1006. The transceiver 1005 may be called a transceiver element, a transceiver machine, a transceiver circuit or the like, for implementing a transceiver function. The transceiver 1005 may include a receiver and a transmitter. The receiver may be called a receiving machine, a receiving circuit or the like, for implementing a receiving function. The transmitter may be called a transmitting machine, a transmitting circuit or the like for implementing a transmitting function.

Optionally, the communication apparatus 1000 may further include at least one interface circuit 1007. The interface circuit 1007 is configured to receive a code instruction and transmit the code instruction to the processor 1001. The processor 1001 runs the code instruction to enable the communication apparatus 1000 to execute the methods as described in the foregoing method embodiments.

The communication apparatus 1000 is the PEGC, and the transceiver 1005 is configured to execute S21 and S22 in FIG. 2; S31, S32, S37 and S38 in FIG. 3; or S52 and S53 in FIG. 5.

The communication apparatus 1000 is the SMF: the transceiver 1005 is configured to execute S22 in FIG. 2; S32, S34 and S37 in FIG. 3; S41 and S43 in FIG. 4; S53 and S55 in FIG. 5; and the processor 1001 is configured to execute S23 and S25 in FIG. 2; S33, S35 and S36 in FIG. 3; S44 in FIG. 4; or S54, S56 and S57 in FIG. 5.

The communication apparatus 1000 is the PCF: the transceiver 1005 is configured to execute S41 and S43 in FIG. 4; and the processor 1001 is configured to execute S42 in FIG. 4.

The communication apparatus 1000 is the PINE, and the transceiver 1005 is configured to execute S21 in FIG. 2; S31 and S38 in FIG. 3; or S52 in FIG. 5.

In an implementation manner, the processor 1001 may include the transceiver configured to implement receiving and sending functions. For example, the transceiver may be a transceiver circuit, an interface, or an interface circuit. The transceiver circuit, the interface or the interface circuit configured to implement the receiving and sending functions may be provided separately or may be integrated together. The above transceiver circuit, interface or interface circuit may be configured to read and write codes/data, or the above transceiver circuit, interface or interface circuit may be configured to transmit or transfer signals.

In an implementation manner, the processor 1001 may have stored therein a computer program 1003 that, when run on the processor 1001, causes the communication apparatus 1000 to implement the method as described in the foregoing method embodiments. The computer program 1003 may be solidified in the processor 1001, and in this case, the processor 1001 may be implemented by a hardware.

In an implementation manner, the communication apparatus 1000 may include a circuit, and the circuit may implement the sending, receiving or communicating function in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured with various IC process technologies, such as a complementary metal oxide semiconductor (CMOS), an nMetal-oxide-semiconductor (NMOS), a P-type metal oxide semiconductor (PMOS, also called positive channel metal oxide semiconductor), a bipolar junction transistor (BJT), a bipolar CMOS (BiCMOS), silicon germanium (SiGe), gallium arsenide (GaAs), etc.

The communication apparatus described in the above embodiments may be the terminal, may also be the SMF, may also be the PCF, or may also be the core network, but the scope of the communication apparatus described in the present disclosure is not limited thereto, and a structure of the communication apparatus is not limited by FIG. 9. The communication apparatus may be a stand-alone device or may be a part of a larger device. For example, the communication apparatus may be:
(1) a stand-alone integrated circuit (IC), or a chip, or a chip system or a subsystem;
(2) a set of one or more ICs, optionally, the set of ICs may also include a storage component for storing data and computer programs;
(3) an ASIC, such as a modem;
(4) a module that may be embedded in other devices;
(5) a receiver, a terminal, an intelligent terminal, a cellular phone, a wireless device, a handheld machine, a mobile unit, a vehicle device, a network device, a cloud device, an artificial intelligence device, etc.;
(6) others.

For the case where the communication apparatus may be a chip or a chip system, reference may be made to FIG. 10, which is a block diagram of a chip according to embodiments of the present disclosure.

As shown in FIG. 10, the chip 1100 includes a processor 1101 and an interface 1103. In the chip, at least one processor 1101 may be provided, and more than one interface 1103 may be provided.

For the case where the chip is used to implement functions of the PEGC in embodiments of the present disclosure, the interface 1103 is configured to receive a code instruction and transmit it to the processor, and the processor 1101 is configured to run the code instruction to perform the method for the access authentication for the PINE described in some of the above embodiments.

For the case where the chip is used to implement functions of the SMF in embodiments of the present disclosure, the interface 1103 is configured to receive a code instruction and transmit it to the processor; and the processor 1101 is configured to run the code instruction to perform the method for the access authentication for the PINE described in some of the above embodiments.

For the case where the chip is used to implement functions of the PINE in embodiments of the present disclosure, the interface 1103 is configured to receive a code instruction and transmit it to the processor; and the processor 1101 is configured to run the code instruction to perform the method for the access authentication for the PINE described in some of the above embodiments.

For the case where the chip is used to implement functions of the PCF in embodiments of the present disclosure, the interface 1103 is configured to receive a code instruction and transmit it to the processor; and the processor 1101 is configured to run the code instruction to perform the method for the access authentication for the PINE described in some of the above embodiments.

Optionally, the chip 1100 further includes a memory 1102 for stori ng necessary computer programs and data.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the described functions, but such implementation should not be understood as beyond the protection scope of embodiments of the present disclosure.

Embodiments of the present disclosure further provide an access authentication system, the system includes the communication apparatus as the PEGC, the communication apparatus as the PINE, the communication apparatus as the SMF and the communication apparatus as the PCF in the aforementioned embodiments of FIG. 7, or the system includes the communication apparatus as the PEGC, the communication apparatus as the PINE, the communication apparatus as the SMF and the communication apparatus as the PCF in the aforementioned embodiments of FIG. 9.

The present disclosure further provides a non-transitory computer-readable storage medium having stored therein instructions that, when executed by a computer, cause functions of any of the above method embodiments to be implemented.

The present disclosure further provides a computer program product that, when executed by a computer, causes functions of any of the above method embodiments to be implemented.

The above embodiments may be implemented in whole or in part by a software, a hardware, a firmware or any combination thereof. When implemented using the software, the above embodiments may be implemented in whole or in part in a form of the computer program product. The computer program product includes at least one computer program. When the computer program is loaded and executed on the computer, all or part of the processes or functions according to embodiments of the present disclosure will be generated. The computer may be a general purpose computer, a special purpose computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The non-transitory computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)).

Unless the context otherwise requires, throughout the specification and the claims, terms “comprise/include” and its other forms such as a third person singular form “comprises/includes” and a present participle form “comprising/including” are interpreted as open and inclusive, it means “including, but not limited to”. In the descriptions of the specification, the terms “some embodiments”, “exemplary embodiments” or the like are intended to indicate that a particular feature, structure, material or characteristic associated with the embodiment or example is included in at least one embodiment or example of the present disclosure. The example representations of the above terms do not necessarily refer to a same embodiment or example. In addition, the particular feature, structure, material or characteristic may be included in any one or more embodiments or examples in any suitable manner.

Those of ordinary skill in the art can understand that the first, second, and other numeral numbers involved in the present disclosure are only for convenience of description, and are not intended to limit the scope of embodiments of the present disclosure, nor are they intended to represent a sequential order.

“At least one” in the present disclosure may also be described as one or more, and “a plurality of/multiple” may be two, three, four, or more, and the present disclosure is not limited thereto. In embodiments of the present disclosure, for a kind of technical features, the technical features in this kind of technical features are distinguished by “first”, “second”, “third”, “A”, “B”, “C” and “D”, etc. and there is no order of precedence or order of magnitude among the technical features described with the “first”, “second”, “third”, “A”, “B”, “C” and “D”. The expression “A and/or B” includes following three cases: only A, only B, and a combination of A and B.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, apparatus and unit may refer to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A method for access authentication for a personal Internet of Things networks element (PINE), performed by a personal Internet of Things networks element with gateway capability (PEGC), comprising:
receiving an access request sent by the PINE, wherein the access request comprises identity information of the PINE; and
sending a protocol data unit (PDU) session modification request to a session management function (SMF).

2. The method according to claim 1, further comprising:
receiving a configuration parameter sent by the SMF; and
sending an access response to the PINE.

3. The method according to claim 1, before receiving the access request sent by the PINE, further comprising:
establishing a PDU session with the SMF.

4. The method according to claim 1, wherein the PDU session modification request comprises at least one of:
the identity information of the PINE;
an address of the PINE;
a port of the PINE;
PIN information of a PIN to which the PINE belongs;
an address of an authentication, authorization, and accounting (AAA) server; or
a fully qualified domain name (FQDN) of an AAA server, or
the access request further comprises at least one of:
PIN information of a PIN to which the PINE belongs;
an address of an AAA server; or
an FODN of an AAA server.

5. (canceled)

6. The method according to claim 4, wherein the PIN information of the PIN to which the PINE belongs comprises at least one of:
identification information of the PIN;
identity information of a PEGC in the PIN;
identity information of a PIN element with management capability (PEMC) in the PIN;
identity information of a PEGC to which the PINE belongs in the PIN; or
identity information of a PEGC associated with the PINE in the PIN.

7. The method according to claim 1, wherein the identity information of the PINE comprises at least one of:
extensible authentication protocol (EAP) identity information of the PINE;
a media access control (MAC) address of the PINE;
a permanent equipment identifier of the PINE;
a device identification (ID) of the PINE; or
a PINE ID of the PINE.

8. A method for access control for a PINE, performed by an SMF, comprising:
receiving a PDU session modification request sent by a PEGC, wherein the PDU session modification request is sent by the PEGC in a case where the PEGC receives an access request sent by the PINE, and the access request comprises identity information of the PINE; and
triggering an identity authentication of the PINE according to the PDU session modification request.

9. The method according to claim 8, wherein triggering the identity authentication of the PINE according to the PDU session modification request comprises:
determining a target AAA server; and
triggering the identity authentication of the PINE by sending EAP identity information of the PINE in the PDU session modification request to the target AAA server.

10. The method according to claim 9, wherein determining the target AAA server comprises:
determining the target AAA server according to at least one of:
an address of an AAA server;
a fully qualified domain name (FQDN) of an AAA server;
the EAP identity information of the PINE; or
local configuration of the SMF.

11. The method according to claim 8, further comprising:
determining authenticated EAP identity information of the PINE in response to receiving EAP authentication success information.

12. The method according to claim 11, wherein determining the authenticated EAP identity information of the PINE comprises:
determining that authenticated EAP identity information is the authenticated EAP identity information of the PINE, in response to EAP identity information of the PINE being anonymous EAP identity information and the EAP authentication success information comprising the authenticated EAP identity information; or
determining that the authenticated EAP identity information of the PINE is common EAP identity information in the PDU session modification request, in response to EAP identity information of the PINE being common EAP identity information.

13. The method according to claim 9, wherein triggering the identity authentication of the PINE by sending the EAP identity information of the PINE in the PDU session modification request to the target AAA server comprises:
performing the identity authentication of the PINE by transmitting an EAP message between the PINE and the target AAA server using at least one of an address or a port of the PINE in the PDU session modification request, in response to the EAP identity information of the PINE being anonymous EAP identity information.

14. (canceled)

15. The method according to claim 11, further comprising:
determining a configuration parameter corresponding to the PINE.

16. The method according to claim 15, wherein determining the configuration parameter corresponding to the PINE comprises:
sending a query request to a policy control function (PCF);
receiving a configuration policy sent by the PCF; and
determining the configuration parameter corresponding to the PINE according to the configuration policy,
wherein the query request comprises at least one of:
the authenticated EAP identity information of the PINE;
PIN information of a PIN to which the PINE belongs; or
the identity information of the PINE.

17. The method according to claim 16, further comprising:
modifying a PDU session suitable for the PINE between the PEGC and the SMF according to the configuration parameter.

18-22. (canceled)

23. A method for access control for a PINE, performed by the PINE, comprising:
sending an access request to a PEGC associated with the PINE or a PEGC to which the PINE belongs, wherein the access request comprises identity information of the PINE.

24. The method according to claim 23, further comprising at least one of:
receiving an EAP authentication request message sent by the PEGC; and sending an EAP authentication response to the PEGC, or
receiving an access response sent by the PEGC.

25-38. (canceled)

39. A communication apparatus, comprising:
a processor; and
a memory having stored therein computer programs,
wherein the processor is configured to perform the method according to claim 1.

40-41. (canceled)

42. A communication apparatus, comprising:
a processor; and
a memory having stored therein computer programs,
wherein the processor is configured to perform the method according to claim 8.

43. A communication apparatus, comprising:
a processor; and
a memory having stored therein computer programs,
wherein the processor is configured to perform the method according to claim 23.
